(19) United States
(12) Patent Application Publication
(10) Pub. No.: US 2026/0099083 A1
(43) Pub. Date: Apr. 9, 2026

(54) JIG AND AIMING METHOD

(71) Applicant: TOYOTA JIDOSHA KABUSHIKI KAISHA, Toyota-shi (JP)

(72) Inventor: Takeshi AMEMIYA, Nagoya-shi (JP)

(73) Assignee: TOYOTA JIDOSHA KABUSHIKI KAISHA, Toyota-shi (JP)

(21) Appl. No.: 19/252,822

(22) Filed: Jun. 27, 2025

(30) Foreign Application Priority Data
Oct. 9, 2024 (JP) 2024-177479

(51) Int. Cl. G03B 17/56

(52) U.S. Cl. CPC G03B 17/561

(57) ABSTRACT

A jig for use in an aiming work of a camera mounted on a vehicle includes a plurality of scale marks arranged in accordance with a width of the vehicle, one of which is aligned with a center line of the vehicle, and a first marker arranged apart from the graduations in accordance with the width and for confirming the connection of an image between a first camera positioned in the front-rear direction of the vehicle and a second camera positioned in a side direction intersecting the front-rear direction.

### CROSS-REFERENCE TO RELATED APPLICATION

This application claims priority to Japanese Patent Application No. 2024-177479 filed on Oct. 9, 2024. The disclosure of the above-identified application, including the specification, drawings, and claims, is incorporated by reference herein in its entirety.

### BACKGROUND

### 1. Technical Field

The present disclosure relates to a jig and an aiming method.

### 2. Description of Related Art

Conventionally, there is known technology for more easily and accurately performing aiming of a device that is installed in a vehicle. For example, Japanese Unexamined Patent Application Publication No. 2024-100450 (JP 2024-100450 A) discloses the following aiming method: a laser beam is emitted from a laser device that is installed at a middle position rearward of a vehicle, a laser target is installed in front of the vehicle such that the laser beam that is emitted passes through a slit portion thereof, and an aiming target is installed at a position that is level with the laser target. A recognition device that recognizes the front of the vehicle recognizes the aiming target.

### SUMMARY

Vehicle widths may vary one from another depending on vehicle model, and accordingly, depending on the vehicle model, handling with the conventional aiming method may be difficult. The present disclosure provides a jig and an aiming method that can more easily perform aiming work even when a vehicle widths vary depending on vehicle models.

A jig according to an embodiment of the present disclosure is a jig used in aiming work of a camera that is installed in a vehicle, the jig including
a plurality of scale marks that is disposed in accordance with a width of the vehicle, one of which is aligned with a center line of the vehicle, and
a first marker for confirming connection of images between a first camera that is situated in a front-rear direction of the vehicle and a second camera that is situated in a lateral direction intersecting the front-rear direction, the first marker being provided spaced apart from the scale marks in accordance with the width.

An aiming method according to an embodiment of the present disclosure is performed for a camera that is installed in the vehicle, using the jig.

According to an embodiment of the present disclosure, a jig and an aiming method can be provided that enable aiming work to be performed more easily even when vehicle widths vary depending on vehicle models.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a configuration of a jig according to an embodiment of the present disclosure;

FIG. 2 is a schematic diagram illustrating an exemplary arrangement of the jig of FIG. 1 with respect to vehicles; and

FIG. 3 is a schematic diagram illustrating an example of the arrangement of a target with respect to a jig arranged together with the vehicle of FIG. 2.

### DETAILED DESCRIPTION OF EMBODIMENTS

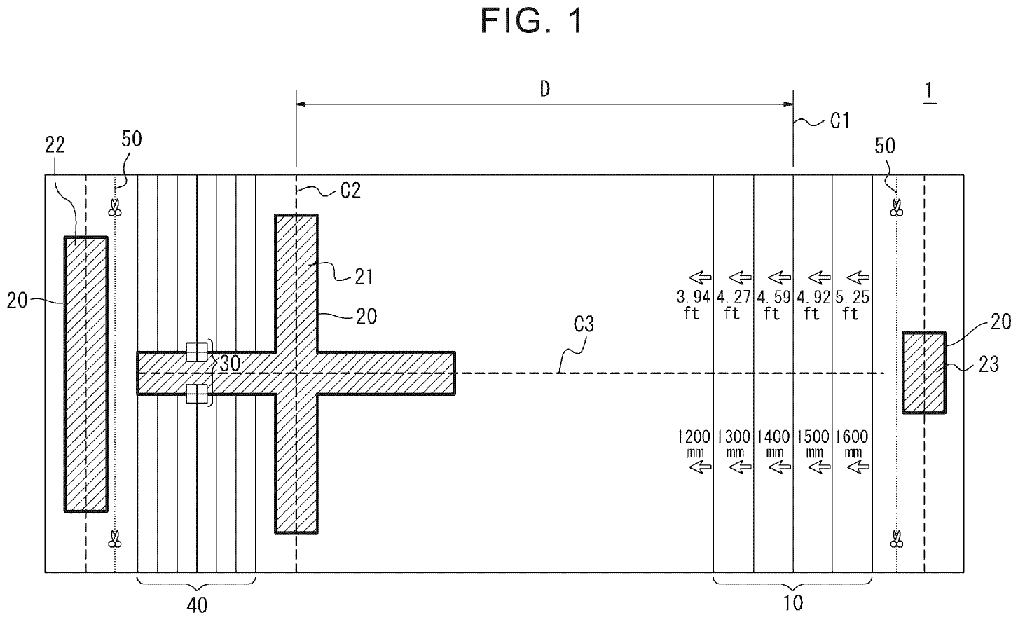

Hereinafter, an embodiment of the present disclosure will be described with reference to the accompanying drawings. FIG. 1 is a schematic diagram illustrating an example of a configuration of a jig 1 according to an embodiment of the present disclosure. The jig 1 is used for an aiming work of a camera mounted on a vehicle.

The jig 1 includes a scale mark 10, a plurality of markers 20 including a first marker 21, a second marker 22, and a third marker 23, a position marker 30, an auxiliary line 40, and a cutting line 50. The jig 1 is configured as a sheet on which a scale mark 10, a first marker 21, a second marker 22, and a third marker 23 are drawn. For example, the jig 1 is configured as a single sheet in which the position marker 30, the auxiliary line 40, and the cutting line 50 are drawn in addition to the scale mark 10 and the plurality of markers 20.

The material of the jig I may be any material as long as it is, for example, resistant to tearing and fastness, resistant to moisture and water, and/or resistant to stains and stain. For example, the material of the jig I may be polypropylene. For example, the jig 1 has a rectangular shape having a short side and a long side as a whole.

A plurality of scale marks 10 are arranged according to the width of the vehicle, and one of the graduations is aligned with the center line C1 of the vehicle. The scale mark 10 is drawn on the jig 1 as, for example, a straight line extending substantially over the entire short side of the jig 1 along the short side direction of the jig 1. The plurality of scale marks 10 are arranged at equal intervals along the longitudinal direction of the jig 1 on one side in the longitudinal direction of the jig 1. In the present disclosure, the “lateral direction” is, for example, a direction along the short side of the jig 1. The “longitudinal direction” is, for example, a direction along the long side of the jig 1.

The scale mark 10 also includes a numerical value indicating a distance D from the lateral center line C1 of the vehicle to the longitudinal center line C2 of the first marker 21. The distance D is determined according to the vehicle type of the vehicle. FIG. 1 shows, by way of example, the distance D when the center line C1 of a vehicle of a given vehicle type is aligned with the scale mark 10 located in the longitudinal center of the five scale marks 10. The numerical values included in the scale mark 10 are indicated in parallel corresponding to the widths of the vehicles in a plurality of units that differ from each other with respect to one distance D, such as 1400 mm and 4.59 ft. In the jig 1, when a sentence such as a precaution is drawn together, the sentence may be written together in a plurality of languages different from each other.

The first marker 21 of the plurality of markers 20 is disposed so as to be spaced apart from the scale mark 10 in accordance with the width of the vehicle, and is used to confirm the connection of the image between the first camera located in the front-rear direction of the vehicle and the second camera located in the side direction intersecting the front-rear direction. The first marker 21 is drawn on the jig 1 as a cross shape, for example. On the other side in the longitudinal direction, the first marker 21 is spaced apart from the scale mark 10 by a distance D corresponding to the width of the vehicle. The center line C2 in the longitudinal direction of the first marker 21 is drawn on the jig 1 as a straight line extending along the short side of the jig 1 substantially over the entire short side. The center line C3 of the first marker 21 in the lateral direction is drawn on the jig 1 as a straight line extending along the longitudinal direction.

The second marker 22 of the plurality of markers 20 is used to check whether the first camera located in the front-rear direction of the vehicle can capture an image in parallel. The second marker 22 is drawn on the jig 1 as, for example, a linear shape. The second marker 22 is disposed on the other side in the longitudinal direction so as to be adjacent to the first marker 21 on the outer side in the longitudinal direction.

The third marker 23 of the plurality of markers 20 is used to check whether the second camera located in the lateral direction of the vehicle is able to capture an image in parallel. The third marker 23 is drawn on the jig 1 as a linear shape, for example. The third marker 23 is disposed on one side in the longitudinal direction so as to be adjacent to the scale mark 10 on the outer side in the longitudinal direction. The length of the straight line of the third marker 23 is shorter than the length of the straight line of the second marker 22, for example.

The position marker 30 is disposed with respect to the first marker 21, and is used for installing a first target T1, which will be described later, for measuring the distance to the first camera located in the front-rear direction of the vehicle. The position marker 30 is drawn on the jig 1 as, for example, a pair of markers in which a cross-shaped line is arranged in a rectangular frame so as to be separated from each other along the lateral direction. The position marker 30 is located on the other side in the longitudinal direction and on the outer side in the longitudinal direction with respect to the center line C2 of the first marker 21. The position marker 30 is disposed so as to partially overlap one side along the longitudinal direction of the first marker 21.

A plurality of auxiliary lines 40 are arranged according to the widths of the vehicles, and one of the auxiliary lines is used for installing a second target T2, which will be described later, for measuring the distances from the second cameras. The auxiliary line 40 is drawn on the jig 1 as, for example, a straight line extending substantially over the entire short side of the jig 1 along the short-side direction. On the other side in the longitudinal direction, the auxiliary line 40 is located on the outer side in the longitudinal direction with respect to the center line C2 of the first marker 21. The plurality of auxiliary lines 40 are arranged at equal intervals along the longitudinal direction on the other side in the longitudinal direction. For example, the distance between one auxiliary line 40 and another auxiliary line 40 adjacent to one auxiliary line 40 is smaller than the distance between one scale mark 10 and another scale mark 10 adjacent to one scale mark 10. In FIG. 1, seven auxiliary lines 40 are drawn on the jig 1 along the longitudinal direction.

The cutting line 50 is used to separate each of the second marker 22 and the third marker 23 from one sheet of the jig 1. Two cutting lines 50 are drawn on the jig 1 as, for example, a straight line extending substantially over the entire short side of the jig 1 along the lateral direction. One cutting line 50 is located between the auxiliary line 40 and the second marker 22 located on the outermost side in the longitudinal direction of the plurality of auxiliary lines 40. The two cutting lines 50 are located between the longitudinally outermost scale marks 10 and the third marker 23 of the plurality of scale marks 10.

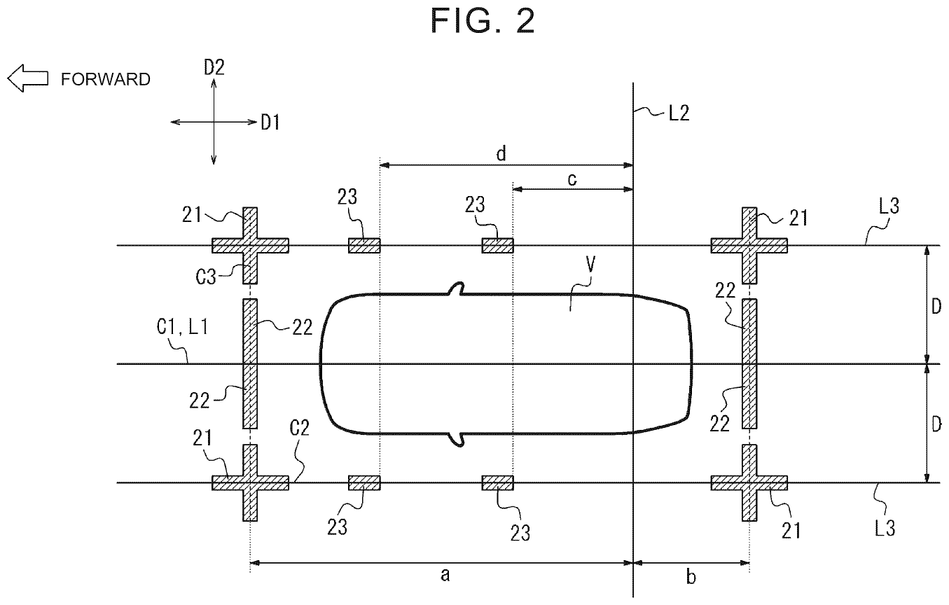

FIG. 2 is a schematic diagram illustrating an example of the arrangement of the jig 1 of FIG. 1 with respect to the vehicle V. For example, the jig 1 is used for an aiming work as a pair of sheets in which the respective configurations shown in FIG. 1 are drawn symmetrically and the print patterns are different from each other, or as two sheets in which the print patterns are the same and are arranged in an inverted manner. The jig 1 is arranged with respect to the vehicle V such that the lateral direction is parallel to the front-rear direction D1 of the vehicle V and the longitudinal direction is parallel to the lateral direction D2 of the vehicle V.

When the aiming work is performed, the jig 1 is arranged in a total of four sheets, two sheets in front of the vehicle V and two sheets in rear, with each scale mark 10 aligned with the center line C1 of the vehicle V. For example, each jig 1 is disposed in front of or behind the vehicle V in a state where the second marker 22 and the third marker 23 are cut off by two cutting lines 50, respectively. Among the jigs 1, the scale mark 10, the first marker 21, the position marker 30, and the auxiliary line 40 are disposed in front of or behind the vehicle V while being drawn on one sheet. The two second markers 22 are disposed on the front side and the rear side of the vehicle V by being bonded to each other. Each of the four third markers 23 is disposed on the side of the vehicle V.

More specifically, the four first markers 21 are respectively arranged at four corners of a rectangular shape surrounding the outside of the vehicle V. Two of the four second markers 22 are arranged as one marker in a state of being overlapped with each other in each of the front and the rear of the vehicle V. Two of the four third markers 23 are arranged on the extension of the center line C2 of the lateral direction D2 of the first marker 21 on each side of the side of the vehicle V.

A method of arranging the plurality of markers 20 in the aiming work will be described in detail. First, a marking member including a string, a thread, a rope, a measure, and the like is extended and the center line L1 and the reference line L2 are arranged as markings. For example, the first point is marked by hanging a sharp weight on the front end from a starting point on one side in the lateral direction D2 of the vehicle V to the ground, and the second point is also marked on the ground on the other side of the lateral direction D2. The reference line L2 is arranged by fixing the marking member to the ground so as to pass through the first point and the second point. The starting point includes, for example, an arbitrary place determined for each vehicle type of the vehicle V. For example, the starting point may include a location at the rear of the vehicle, such as the upper end of the bumper of the rear wheel and the end of the mall. For example, the third point is marked by hanging a sharp weight at the tip on the ground so as to pass through the center of the rear emblem of the vehicle V, and the fourth point is marked by hanging a sharp weight at the tip on the ground so as to pass through the center of the front emblem of the vehicle V. The center line L1 is arranged by fixing the marking member to the ground so as to pass through the third point and the fourth point.

The first marker 21 may arrange the seat in such a manner that the scale mark 10 corresponding to the vehicle type of the vehicle V among the plurality of scale marks 10 drawn together with the first marker 21 is aligned with the center line L1 on the seat of the jig 1. Therefore, the vehicle is disposed away from the center line L1 at an appropriate distance D according to the vehicle type. The two second markers 22 bonded to each other are arranged in line symmetry in a lateral direction D2 with respect to the center line L1 by aligning the center line with the center line L1 on the center line C3 drawn on the sheet of the jig 1. The third marker 23 is disposed on the lateral line L3 disposed so as to extend the mark member in the front-rear direction D1 along the center line C2 of the first marker 21.

A distance along the front-rear direction D1 from the reference line L2 of the first marker 21 located in the front is a. The distance along the front-rear direction D1 from the reference line L2 of the first marker 21 located at the rear is b. The third marker 23 located rearward from the reference line L2 along the front-rear direction D1 is c. A distance along the front-rear direction D1 from the reference line L2 of the third marker 23 located at the front side is d. The distances a, b, c, and d are appropriately determined for each vehicle type of the vehicle V with reference to, for example, a table in which appropriate numerical values of these distances are associated for each vehicle type of the vehicle V.

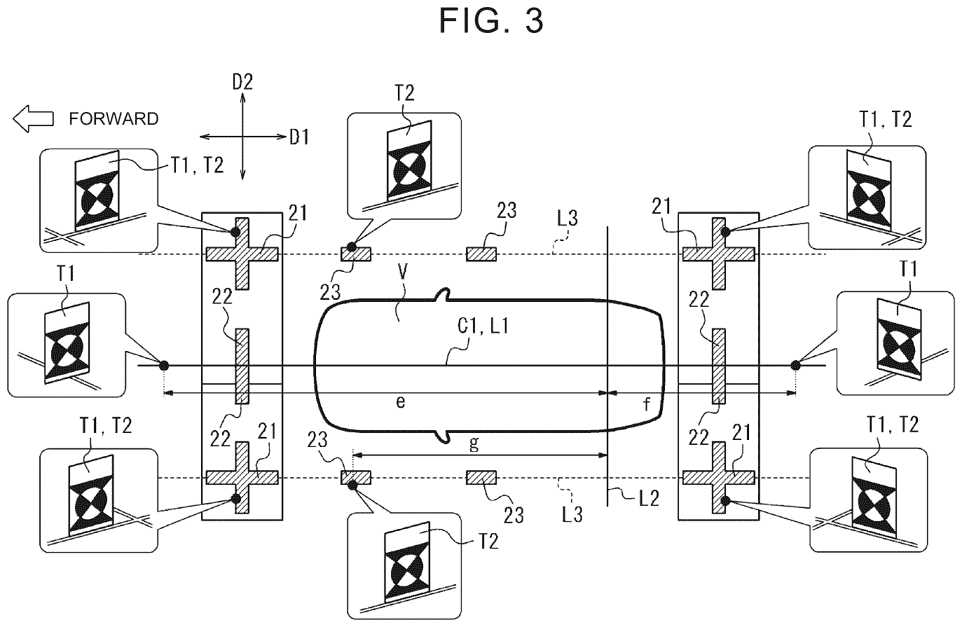

FIG. 3 is a schematic diagram showing an example of the arrangement of the target with respect to the jig 1 arranged together with the vehicle V of FIG. 2. During the aiming work, two targets are arranged in front of the vehicle V and two targets are arranged in rear in accordance with the position marker 30 of the jig 1, one target is arranged on both front and rear sides of the vehicle V on the center line L1, one target is arranged on both sides of the side of the vehicle V, and eight targets are arranged in total.

One target located in front of the vehicle V on the center line L1 and two targets located in front of the vehicle V in accordance with the position marker 30 of the jig 1 constitute three first target T1. Similarly, three first target T1 are arranged behind the vehicles V. Two targets located on both front and rear sides of the vehicle V on one side in the lateral direction D2 in accordance with the position marker 30 of the jig 1, and one target located on the outer side of the lateral line L3 constitute three second target T2. Similarly, three second target T2 are arranged on the other side of the lateral direction D2.

The second target T2 located on the outer side of the lateral line L3 is arranged on a line arranged by extending the mark member in the front-rear direction D1 along the auxiliary line 40 corresponding to the vehicle type of the vehicle V among the plurality of auxiliary lines 40 drawn on the seat of the jig 1. The distance along the front-rear direction D1 from the reference line L2 of the first target T1 located in front of the vehicle V on the center line L1 is e. The distance along the front-rear direction D1 from the reference line L2 of the first target T1 located behind the vehicle V on the center line L1 is f. The distance along the front-rear direction D1 from the reference line L2 of the second target T2 located on the side of the vehicle Vis g. The distances e, f, and g are appropriately determined for each vehicle type of the vehicle V with reference to, for example, a table in which appropriate numerical values of these distances are associated for each vehicle type of the vehicle V.

The aiming method of the camera mounted on the vehicle V is executed using the jig 1 described above. In the aiming process, the first cameras located in front of the vehicles V are adjusted by means of three first target T1 located in front. The first cameras located behind are likewise adjusted by means of three first target T1 located behind. In the aiming process, each of the three first target T1 is used to measure the distance to the first camera of the vehicle V. In the aiming process, the second cameras located laterally of the vehicles V are adjusted by means of three second target T2. In the aiming process, each of the three second target T2 is used to measure the distance to the second camera of the vehicle V.

In the aiming method, the connection between the first image captured by the first camera and the second image captured by the second camera is confirmed by, for example, the state of the cross shape of the first marker 21 displayed on the adjustment screen in the vehicle cabin of the vehicle V. Each of the first camera and the second camera is adjusted by the operator so that the cross shape of the first marker 21 is not asymmetrically shifted with respect to the center, and the cross shape is displayed on the adjustment screen in the correct shape so that the connection of the image is correct.

In the aiming method, whether or not the first camera and the second camera are able to capture an image in parallel is confirmed by, for example, the arrangement of the linear shapes of the captured second marker 22 and the captured third marker 23 with respect to the frame displayed on the adjustment screen in the vehicle cabin of the vehicle V. The first camera is adjusted by the operator so that the linear shape of the second marker 22 fits correctly within the frame. The second camera is adjusted by the operator so that the linear shape of the third marker 23 fits correctly within the frame.

According to the jig 1 according to the embodiment as described above, even when the vehicle width varies depending on the vehicle type, it is possible to more easily perform the aiming work. For example, the operator may align the center line C1 of the vehicle V with the scale mark 10 of the jig 1 for each vehicle type of the vehicle V that is the target of the aiming work of the in-vehicle camera. Therefore, the position of the first marker 21 in the lateral direction D2 with respect to the center line C1 can be easily and appropriately adjusted in accordance with the width of the vehicle V. Only by arranging the jig 1 at an appropriate position for each vehicle type in accordance with the center line C1 of the vehicle V, the first marker 21 on the jig I can be easily and appropriately arranged at a position corresponding to the width of the vehicle V in the aiming work. Therefore, compared with the related art in which the distance is measured a plurality of times around the vehicle V for marker installation, and a gum tape or the like is stuck on the floor to be aligned as a marker for image confirmation of the in-vehicle camera, the working time required for the camera's aiming work is greatly reduced. Unlike the prior art in which the marker is not reusable when formed with a gum tape or the like, it can be repeatedly used for an aiming work of another vehicle V of the same or different vehicle type only by rearranging the jig 1. It is also possible to flexibly cope with an aiming work for a plurality of vehicles V. For example, the jig 1 is installed as two seats on which the position marker 30 indicating the installation position of the target is drawn and shifted in accordance with the vehicle width, thereby enabling an aiming work corresponding to all the vehicle types having different vehicle widths.

It will be apparent to those skilled in the art that the present disclosure may be embodied in other specific forms than those described above without departing from the spirit or essential characteristics thereof. Accordingly, the above description is merely an example and the disclosure is not limited thereto. The scope of the disclosure is defined by the attached claims, not the above description. It will be assumed that some of various modifications that are within a scope equivalent thereto are included therein.

For example, the shapes, patterns, sizes, arrangements, orientations, types, and numbers of the above-described components are not limited to the contents illustrated in the above description and the drawings. The shape, pattern, size, arrangement, direction, type, number, and the like of each component may be arbitrarily configured as long as the function can be realized. Each component of the illustrated jig 1 is a functional concept. The specific form of each component is not limited to that shown in the drawings.

What is claimed is:

1. A jig used in aiming work of a camera that is installed in a vehicle, the jig comprising:
a plurality of scale marks that is disposed in accordance with a width of the vehicle, one of which is aligned with a center line of the vehicle; and
a first marker for confirming connection of images between a first camera that is situated in a front-rear direction of the vehicle and a second camera that is situated in a lateral direction intersecting the front-rear direction, the first marker being provided spaced apart from the scale marks in accordance with the width.

2. The jig according to claim 1, further comprising:
a second marker for confirming whether the first camera is imaging an image in parallel; and
a third marker for confirming whether the second camera is imaging an image in parallel.

3. The jig according to claim 2, wherein the jig is configured as a single sheet in which the scale marks, the first marker, the second marker, and the third marker are drawn.

4. The jig according to claim 1, further comprising a position marker that is disposed on the first marker and that is used for setting a target for measuring a distance to the first camera.

5. The jig according to claim 1, wherein the jig is used in the aiming work as a pair of sheets in which each configuration is drawn symmetrically and a print pattern is different from each other, or as two sheets, in which the print pattern is the same as each other, and that are arranged inversely.

6. An aiming method of a camera that is installed in a vehicle, wherein the jig according to claim 1 is used.
